(19) United States
(12) Patent Application Publication
(10) Pub. No.: US 2009/0121687 A1
(43) Pub. Date: May 14, 2009

(54) Charging method and charging apparatus

(75) Inventors: Michihito Kobayashi, Kanagawa (JP); Masatsugu Honma, Kanagawa (JP); Yuichi Akita, Fukushima (JP); Masanao Sato, Fukushima (JP); Tohru Kurihara, Fukushima (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/290,936

(22) Filed: Nov. 5, 2008

(30) Foreign Application Priority Data
Nov. 12, 2007 (JP) P2007-293559

(51) Int. Cl. H02J 7/00

(52) U.S. Cl. 320/162

(57) ABSTRACT

A charging apparatus for charging a plurality of batteries has at least two modes including a first mode and a second mode, in which amounts of electricity to charge the batteries are set with reference to a fully charged capacity of the batteries. The apparatus includes mode selection means for selecting either of the first mode and the second mode. The first mode is a mode in which the batteries are charged until the batteries reach a fully charged state. The second mode is a mode in which the charging of the batteries is stopped before the batteries reach the fully charged state.

### CROSS REFERENCES TO RELATED APPLICATIONS

The present invention contains subject matter related to Japanese Patent Application JP 2007-293559 filed in the Japanese Patent Office on Nov. 12, 2007, the entire contents of which being incorporated herein by reference.

### BACKGROUND OF THE INVENTION

1. Field of the Invention

The present invention relates to a charging method and a charging apparatus which make it possible to achieve improved charging efficiency when charging a plurality of batteries consecutively.

2. Description of the Related Art

FIG. 7 is a characteristic diagram showing changes in a charge current which occur when a battery pack including lithium ion batteries having a nominal capacity of 1000 mAh is charged with a current of 1 A. As apparent from the characteristic diagram, the charge current of 1 A flows into the battery pack for a period less than 30 minutes after charging is started. The charge current gradually decreases beyond the 30 minutes after the beginning of charging and reaches 0.2 A when 90 minutes pass after the beginning of charging. When charging is further continued until 150 minutes pass after the beginning of charging, the charge current decreases to about 0.05 A, and the battery pack is substantially fully charged.

FIG. 8 is a characteristic diagram showing charged capacity characteristics of the same battery pack. As apparent from the characteristic diagram, when 150 minutes pass after the beginning of charging to fully charge the battery pack, a charged capacity in the excess of 1000 mAh is obtained. When 90 minutes pass after the beginning of charging, a charged capacity near 1000 mAh is obtained, although the nominal capacity is not reached.

FIG. 9 is a characteristic diagram showing charge capacity percentage characteristics of the same battery pack. The charge capacity percentage characteristics indicate changes in charged capacity occurring after charging is started on an assumption that 100% charged capacity is obtained when 150 minutes pass after the beginning of charging or when the battery pack is fully charged. As apparent from the characteristic diagram, 90 percent of the charge capacity is obtained when 90 minutes pass after charging is started. The diagram also indicates that the 100% charge capacity is obtained when 150 minutes pass after charging is started.

Some charging apparatus for charging secondary batteries including lithium ion batteries as thus described are designed to work with a secondary battery having capacity display means provided on a surface of the battery housing. Specifically, capacity display means is detected by detection means provided at a charging apparatus, and a charge current control circuit is controlled according to output of detection to select an optimal charge current (see JP-A-5-174876 (Patent Document 1)).

### SUMMARY OF THE INVENTION

According to charging methods and apparatus in the related art, battery packs are charged until 100% charge capacity is reached regardless of the number of the battery packs to be charged. Therefore, in the case of a charging apparatus having only one charging circuit, when there is a plurality of battery packs to be charged, the battery packs are sequentially charged one after another until the 100% charge capacity is obtained. As a result, charging can take a long time depending on the number of battery packs, and a problem therefore arises in that a user may have to wait for such a long time.

Under the circumstance described above, it is desirable to provide a charging method and a charging apparatus which make it possible to achieve improved charging efficiency in charging a plurality of batteries.

According to an embodiment of the invention, there is provided a charging apparatus charging a plurality of batteries having at least two modes including a first mode and a second mode, in which amounts of electricity to charge the batteries are set with reference to a fully charged capacity of the batteries. The apparatus includes mode selection means for selecting either of the first mode and the second mode. The first mode is a mode in which the batteries are charged until the batteries reach a fully charged state. The second mode is a mode in which the charging of the batteries is stopped before the batteries reach the fully charged state.

According to the embodiment of the invention, there is provided a charging method for charging a plurality of batteries, including the steps of setting amounts of electricity to charge the batteries with reference to a fully charged capacity of the batteries to provide a first mode in which the batteries are charged until the batteries reach a fully charged state and a second mode in which the charging of the batteries is stopped before the batteries reach the fully charged state, and charging the plurality of batteries according to a result of selection made by mode selection means for selecting and enabling either of the first mode and second mode.

The charging method and charging apparatus according to the embodiment of the invention as thus described make it possible to achieve improved charging efficiency in charging a plurality of batteries.

### BRIEF DESCRIPTION OF THE DRAWINGS

FIG. 1 is a block diagram showing a configuration of a charging apparatus utilizing a charging method according to a first embodiment of the invention;

FIG. 2 is a flow chart showing operations of the charging apparatus employing the charging method according to the first embodiment of the invention;

FIG. 3 is a characteristic diagram showing charge current characteristics of a battery pack mounted in a battery slot A and a battery pack mounted in a battery slot B, observed when a 100% charging mode is selected in the first embodiment of the invention;

FIG. 4 is a characteristic diagram showing charge capacity characteristics of a battery pack mounted in the battery slot A and a battery pack mounted in the battery slot B, observed when the 100% charging mode is selected in the first embodiment of the invention;

FIG. 5 is a characteristic diagram showing charge current characteristics of a battery pack mounted in the battery slot A and a battery pack mounted in the battery slot B, observed when a 90% charging mode is selected in the first embodiment of the invention;

FIG. 6 is a characteristic diagram showing charge capacity characteristics of the battery pack mounted in the battery slot A and the battery pack mounted in the battery slot B, observed when the 90% charging mode is selected in the first embodiment of the invention;

FIG. 7 is a characteristic diagram showing changes in a charge current which occur when a battery pack including lithium ion batteries having a nominal capacity of 1000 mAh is charged with a current of 1 A;

FIG. 8 is a characteristic diagram showing charged capacity characteristics observed when the battery pack including lithium ion batteries having a nominal capacity of 1000 mAh is charged with a current of 1 A; and

FIG. 9 is a characteristic diagram showing charge capacity percentage characteristics observed when the battery pack including lithium ion batteries having a nominal capacity of 1000 mAh is charged with a current of 1 A.

### DESCRIPTION OF THE PREFERRED EMBODIMENTS

### First Embodiment

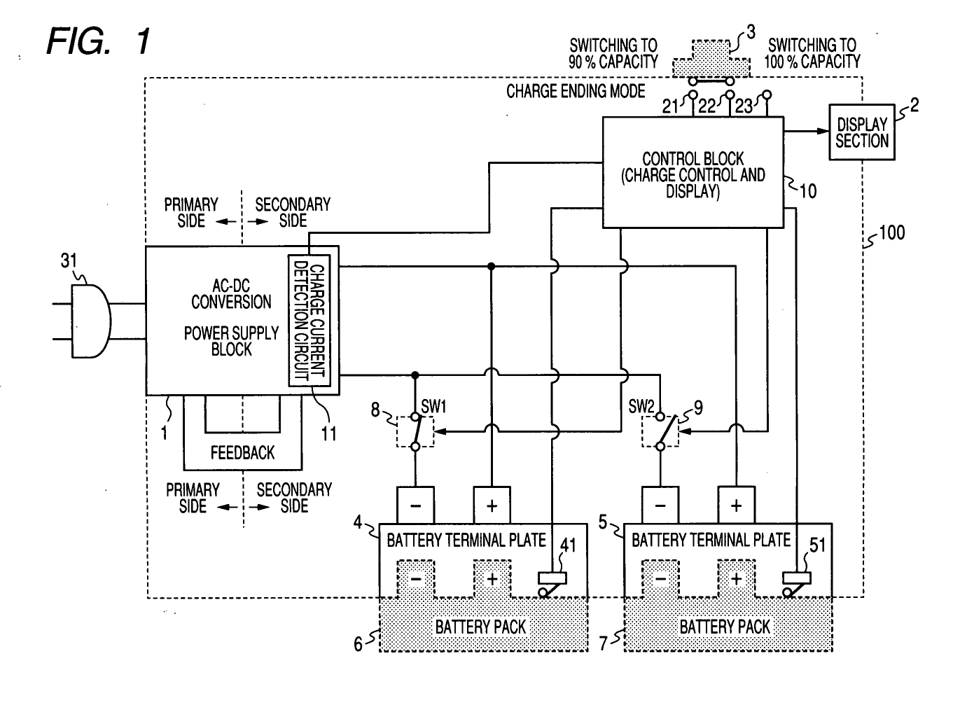

A charging method and a charging apparatus according to a first embodiment of the invention will now be described with reference to the drawings. FIG. 1 is a block diagram showing a configuration of a charging apparatus utilizing a charging method according to the first embodiment of the invention. A charging apparatus 100 includes a power supply block 1, a display section 2, a charge ending mode select switch (mode selection means) 3, a battery terminal plate 4, a battery terminal plate 5, charge control switches 8 and 9, and a control block (mode selection means) 10.

The power supply block 1 converts AC power supplied thereto into DC power.

A charging circuit is formed in the power supply block 1, and the block also includes a charge current detection circuit 11.

The charge current detection circuit 11 is a circuit for detecting a charge current used to charge a battery pack (battery) 6 mounted in a battery slot A formed on the battery terminal plate 4 or a battery pack (battery) 7 mounted in a battery slot B formed on the battery terminal plate 5.

The display section 2 causes, for example, a liquid crystal display to display the state of charging of the battery pack 6 mounted in the battery slot A formed on the battery terminal plate 4 or the battery pack 7 mounted in the battery slot B formed on the battery terminal plate 5 and to display a charge ending mode that is selected using the charge ending mode select switch 3.

The charge ending mode select switch 3 is a switch to select either of a 100% charging mode in which the battery pack is charged until its 100% charge capacity or a 90% charging mode in which the battery pack is charged until its 90% charge capacity.

The charge ending mode select switch 3 used in the present embodiment is a slide switch. When a 90% charging mode is selected, there is continuity between a contact 21 and a contact 22, and there is no continuity between the contact 22 and a contact 23. When a 100% charging mode is selected, there is continuity between the contact 22 and the contact 23, and there is no continuity between the contact 22 and the contact 21.

In the battery slot A formed on the battery terminal plate 4, there is provided charging electrodes to be electrically connected to a positive electrode and a negative electrode of the battery pack 6 mounted in the slot. A battery detection switch 41 is also provided in the slot to detect the mounting of the battery pack 6 in the battery slot A.

The battery detection switch 41 includes a movable member, and the switch is configured to operate when the movable member is operated.

The battery detection switch 41 is mounted in a position where the movable member abuts on a part of, for example, a side surface of the battery pack 6 mounted in the battery slot A formed on the battery terminal plate 4.

When the battery pack 6 is mounted in the battery slot A, the movable member abuts on a part of a side surface of the battery pack 6, and the member is pushed down to switch a contact of the battery detection switch 41 from an open state to a closed state or from the closed state to the open state.

In the battery slot B formed on the battery terminal plate 5, charging electrodes are provided in positions where they will be electrically connected to a positive electrode and a negative electrode of the battery pack 7 mounted in the slot. A battery detection switch 51 is also provided in the slot to detect the mounting of the battery pack 7 in the battery slot B.

The battery detection switch 51 includes a movable member similarly to that of the battery detection switch 41, and the switch is configured to operate when the movable member is operated.

The battery detection switch 51 is mounted in a position where the movable member abuts on a part of, for example, a side surface of the battery pack 7 mounted in the battery slot B formed on the battery terminal plate 5.

When the battery pack 7 is mounted in the battery slot B, the movable member abuts on a part of a side surface of the battery pack 7, and the member is pushed down to switch a contact of the battery detection switch 51 from an open state to a closed state or from the closed state to the open state.

The charge control switch 8 includes a control terminal, and continuity and non-continuity of the switch is controlled by a control signal output from the control block 10 to the control terminal.

In the present embodiment, the charge control switch 8 switches the connection of the negative electrode of the battery pack 6 mounted in the battery slot A formed on the battery terminal plate 4 to the charging circuit. That is, the negative electrode of the battery pack 6 mounted in the slot is switched to be in continuity or non-continuity to the charging circuit by the charge control switch 8.

The charge control switch 9 includes a control terminal, and continuity and non-continuity of the switch is controlled by a control signal output from the control block 10 to the control terminal.

In the present embodiment, the charge control switch 9 switches the connection of the negative electrode of the battery pack 7 mounted in the battery slot B formed on the battery terminal plate 5 to the charging circuit. That is, the negative electrode of the battery pack 7 mounted in the slot is switched to be in continuity or non-continuity to the charging circuit by the charge control switch 9.

The control block 10 controls charging of a battery pack mounted in the battery slot formed on the battery terminal plate 4 or the battery terminal plate 5, and the block also controls indications on the display section 2. For this reason, the control block 10 includes a microcomputer.

The microcomputer includes memories such as a ROM and a RAM, a CPU, I/O ports, various interfaces including a display interface for displaying states of the charge capacity of a battery pack on the display section 2 to show the level of energy accumulated in the battery pack, an A-D converter, and a D-A converter.

The microcomputer detects states of the contacts 21, 22, and 23 of the charge ending mode select switch 3 through the I/O ports to determine which of the 100% charging mode or 90% charging mode is selected by the charge ending mode select switch 3. The microcomputer fetches a charge current detected by the charge current detection circuit 11 through the A-D converter as digital data and controls charging of a battery pack.

The microcomputer also detects states of the contacts of the battery detection switches 41 and 51 through the I/O ports to determine whether a battery pack is mounted on the battery terminal plate 4 or the battery terminal plate 5.

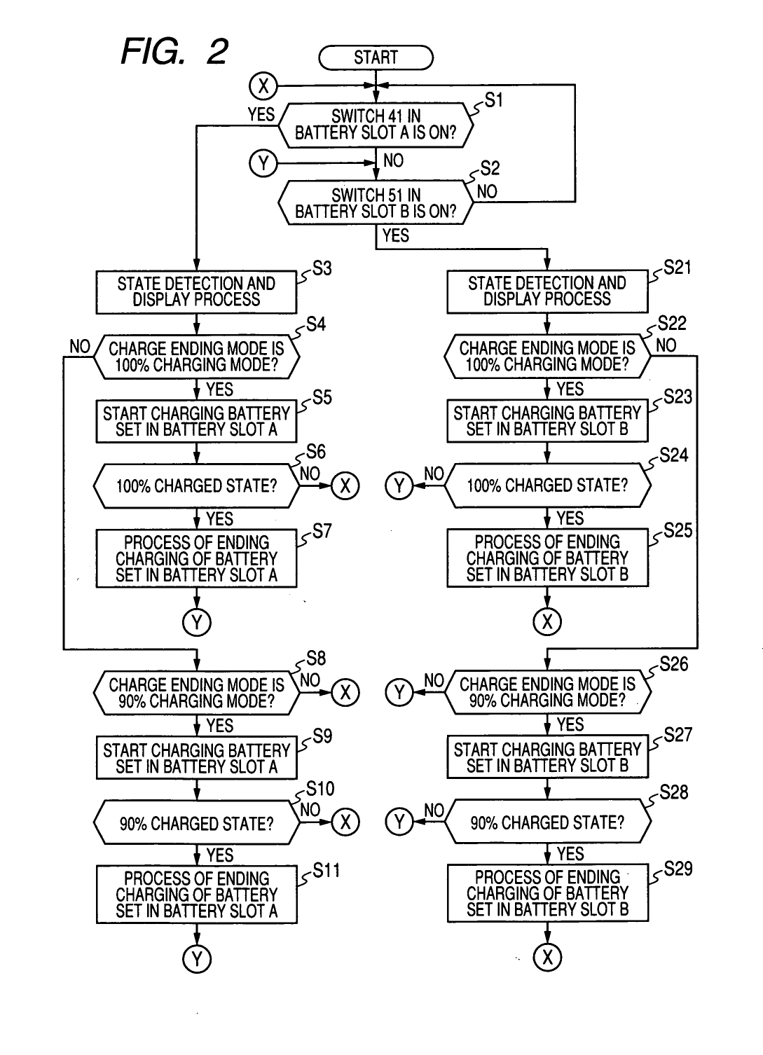

A control program, which is shown in the flow chart of FIG. 2, is stored in the ROM.

The microcomputer executes the control program to control display operations at the display section 2, to control the charge control switches 8 and 9, and to control charging of a battery pack mounted in the battery slot of the battery terminal plate 4 or the battery terminal plate 5.

Operations of the charging apparatus will now be described.

FIG. 2 is a flow chart showing operations of the charging apparatus employing a charging method according to the present embodiment of the invention. The operations of the apparatus will be described below with reference to the flow chart.

When a plug 31 of the charging apparatus is connected to a commercial power supply to supply the apparatus with AC power, the microcomputer of the control block 10 first executes an initializing operation to make various initial settings. When the initializing operation is finished, it is determined whether the battery detection switch 41 provided in the battery slot A formed on the battery terminal plate 4 is on or not (step S1). If the battery detection switch 41 is not on, it is determined whether the battery detection switch 51 provided in the battery slot B formed on the battery terminal plate 5 is on or not (step S2). Through the processes performed at steps S1 and S2, it is determined which of the battery slots A and B has been first loaded with a battery pack. When the battery slots A and B are simultaneously loaded with batteries, priority is given to the battery slot A in most cases. It is determined that the battery slot A has been loaded with a battery pack earlier in such a case.

When it is determined at step S1 that the battery detection switch 41 is on, a state detection and display process is subsequently executed (step S3). At the state detection and display process, the battery slot which has been loaded with a battery pack is determined from states of the contacts of the battery detection switch 41 and the battery detection switch 51. A flag “1” is set in a register associated with the battery slot A to indicate that the slot is loaded with a battery pack 6 and that the battery pack 6 will be charged.

After the charging circuit of the power supply block 1 starts charging, a charge current flowing into the battery pack 6 detected by the charge current detection circuit 11 is converted into digital data by the A-D converter. The amount of energy or charge presently accumulated in the battery pack 6 that is being charged is determined based on the digital data. A state indication is provided using, for example, bar graphics to show the present amount of energy accumulated in the battery pack 6 being charged, based on the charge capacity thus determined. The present amount of energy accumulated in the battery pack 6 being charged may alternatively be determined by detecting a voltage across terminals of the battery pack 6 instead of determining the amount by detecting the charge current using the charge current detection circuit 11.

It is determined which of the 100% charging mode and the 90% charging mode has been selected using the charge ending mode select switch 3. The determination of the charge ending mode is made based on the states of the contacts 21, 22, and 23 of the charge ending mode select switch 3. Specifically, when there is continuity between the contacts 21 and 22, it is determined that the 90% charging mode has been selected. When there is continuity between the contacts 22 and 23, it is determined that the 100% charging mode has been selected. The result of such determination is stored in a memory, and the state of charging of the battery pack is displayed on the display section 2 based on the flag and the result of determination.

When it is determined at step S4 that the 100% charging mode has been selected from the result of determination of the charge ending mode, the process proceeds to step S5.

At step S5, the charging circuit is turned on, and control is exercised to put the charge control switch 9 in the state in non-continuity and to put the charge control switch 8 in the state in continuity, whereby charging of the battery pack 6 mounted in the battery slot A is started. The charge current supplied to the battery pack 6 is detected by the charge current detection circuit 11, and it is determined whether the battery pack 6 has been charged 100 percent or not from the magnitude of the detected charge current (step S6). When it is determined that the battery pack has not been charged 100 percent yet, the process returns to step S1 to repeat the processes at steps S1 to S6. When the battery pack 6 is charged 100 percent, the process proceeds from step S6 to step S7 at which a process of ending the charging of the battery pack 6 is performed, and the process returns to step S2. The charge ending process includes a process of providing a full-charge indication to show that the battery pack 6 has been charged 100 percent.

When the 90% charging mode has been selected using the charge ending mode select switch 3, the process proceeds from step S4 to step S8. At subsequent step S9, the charging circuit is turned on, and control is exercised to put the charge control switch 9 in the state in non-continuity and to put the charge control switch 8 in the state in continuity, whereby charging of the battery pack 6 mounted in the battery slot A is started. The charge current supplied to the battery pack 6 is detected by the charge current detection circuit 11, and it is determined whether the battery pack 6 has been charged 90 percent or not from the magnitude of the detected charge current (step S10). When it is determined that the battery pack has not been charged 90 percent yet, the process returns to step S1 to repeat the processes at steps S1 to S4 and processes at step S8 to S10. When the battery pack 6 is charged 90 percent, the process proceeds from step S10 to step S11 at which a process of ending the charging of the battery pack 6 is performed, and the process returns to step S2.

It is determined at step S2 that the battery detection switch 51 is on when the battery slots A and B are substantially simultaneously loaded with battery packs and priority is given to a battery pack 6 mounted in the battery slot A. Such a determination is made also when a battery pack 7 is mounted in the battery slot B after a battery pack 6 is mounted in the battery slot A. Then, the process proceeds from step S2 to step S21.

At step S21, a state detection and display process is executed. At the state detection and display process, the battery slot which has been loaded with a battery pack is determined from states of the contacts of the battery detection switch 41 and the battery detection switch 51. A flag “1” is set in a register associated with the battery slot B to indicate that the slot is loaded with a battery pack 7 and that the battery pack 7 will be charged.

After the charging circuit starts charging, a charge current flowing into the battery pack 7 detected by the charge current detection circuit 11 is converted into digital data by the A-D converter. The amount of energy or charge presently accumulated in the battery pack 7 that is being charged is determined based on the digital data. A state indication is provided using, for example, bar graphics to show the present amount of energy accumulated in the battery pack 7 being charged, based on the charge capacity thus determined. The present amount of energy accumulated in the battery pack 7 being charged may alternatively be determined by detecting a voltage across terminals of the battery pack 7 instead of determining the amount by detecting the charge current using the charge current detection circuit 11. It is determined which of the 100% charging mode and the 90% charging mode has been selected using the charge ending mode select switch 3. The result of such determination of the charge ending mode is stored in a memory and displayed on the display section 2.

When it is determined at step S22 that the 100% charging mode has been selected from the result of determination of the charge ending mode, the process proceeds to step S23.

At step S23, the charging circuit is turned on, and control is exercised to put the charge control switch 9 in the state in continuity and to put the charge control switch 8 in the state in non-continuity, whereby charging of the battery pack 7 mounted in the battery slot B is started. The charge current supplied to the battery pack 7 is detected by the charge current detection circuit 11, and it is determined whether the battery pack 7 has been charged 100 percent or not from the magnitude of the detected charge current (step S24). When it is determined that the battery pack has not been charged 100 percent yet, the process returns to step S2 to repeat the relevant processes among steps S2 to S24. When the battery pack 7 is charged 100 percent, the process proceeds from step S24 to step S25 at which a process of ending the charging of the battery pack 7 is performed, and the process returns to step S1. The charge ending process includes a process of providing a full-charge indication to show that the battery pack 7 has been charged 100 percent.

When the 90% charging mode has been selected using the charge ending mode select switch 3, the process proceeds from step S22 to step S26. At subsequent step S27, the charging circuit is turned on, and control is exercised to put the charge control switch 9 in the state in continuity and to put the charge control switch 8 in the state in non-continuity, whereby charging of the battery pack 7 mounted in the battery slot B is started. The charge current supplied to the battery pack 7 is detected by the charge current detection circuit 11, and it is determined whether the battery pack 7 has been charged 90 percent or not from the magnitude of the detected charge current (step S28). When it is determined that the battery pack has not been charged 90 percent yet, the process returns to step S2 to repeat the processes at steps S2, S22, and S26 to S28. When the battery pack 7 is charged 90 percent, the process proceeds from step S28 to step S29 at which a process of ending the charging of the battery pack 7 is performed, and the process returns to step S1.

As described above, the charging apparatus employing the charging method according to the present embodiment has a 90% charging mode in addition to a 100% charging mode. A user can select the 90% charging mode or the 100% charging mode using the charge ending mode select switch 3.

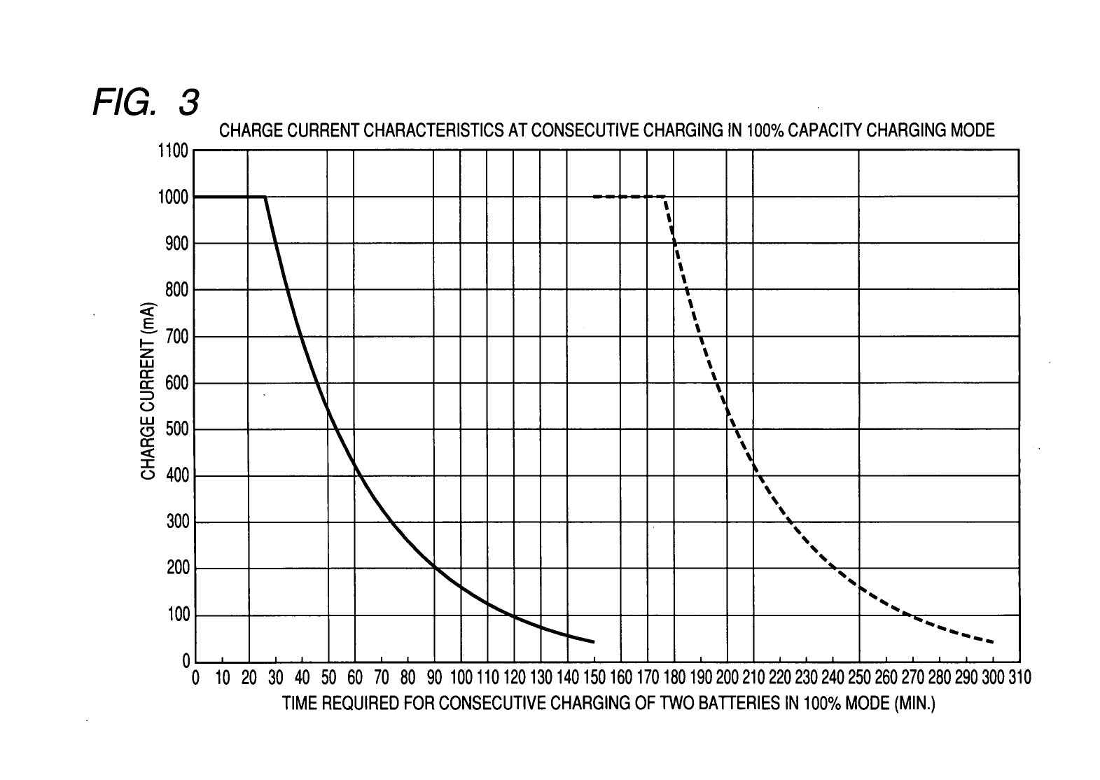

FIG. 3 is a characteristic diagram showing charge current characteristics of a battery pack 6 mounted in the battery slot A and a battery pack 7 mounted in the battery slot B, observed when the 100% charging mode is selected.

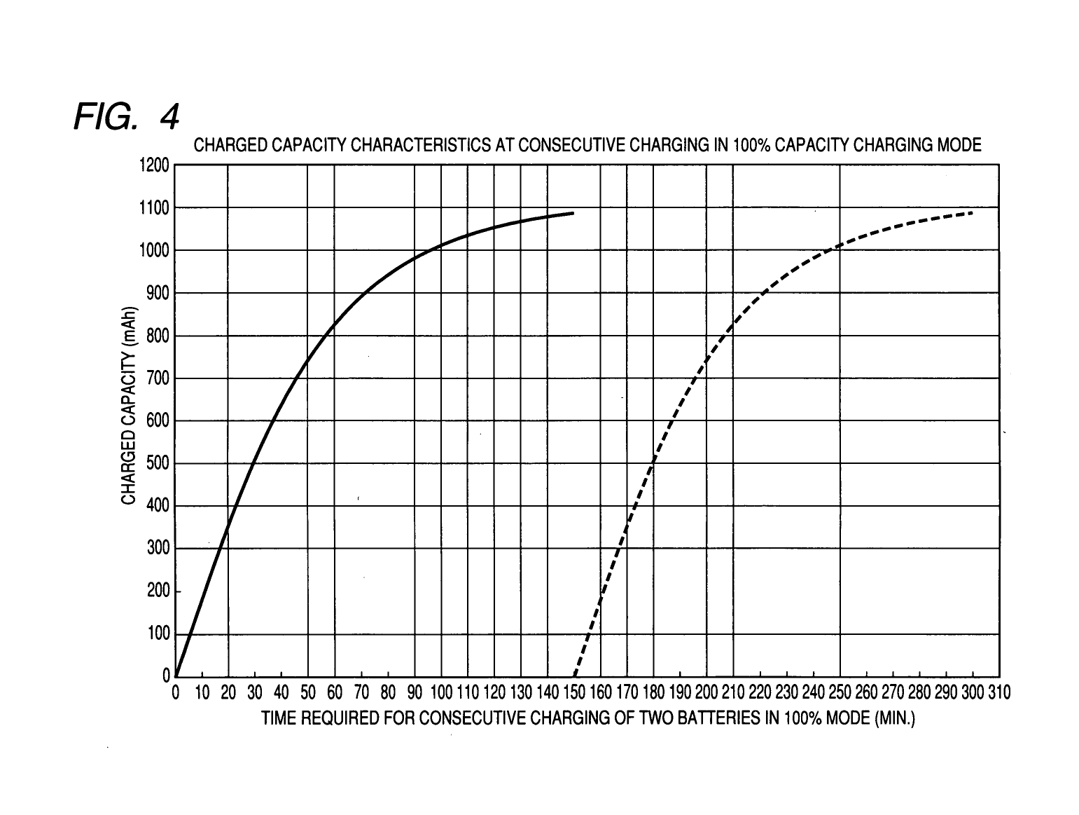

FIG. 4 is a characteristic diagram showing charge capacity characteristics of the battery pack 6 mounted in the battery slot A and the battery pack 7 mounted in the battery slot B, observed when the 100% charging mode is similarly selected.

The charge current characteristics of the battery packs 6 and 7 shown in FIG. 3 indicate that it takes 150 minutes to charge one battery pack 100 percent. Therefore, it takes 300 minutes in total to charge the two battery packs 6 and 7 100 percent in a consecutive manner.

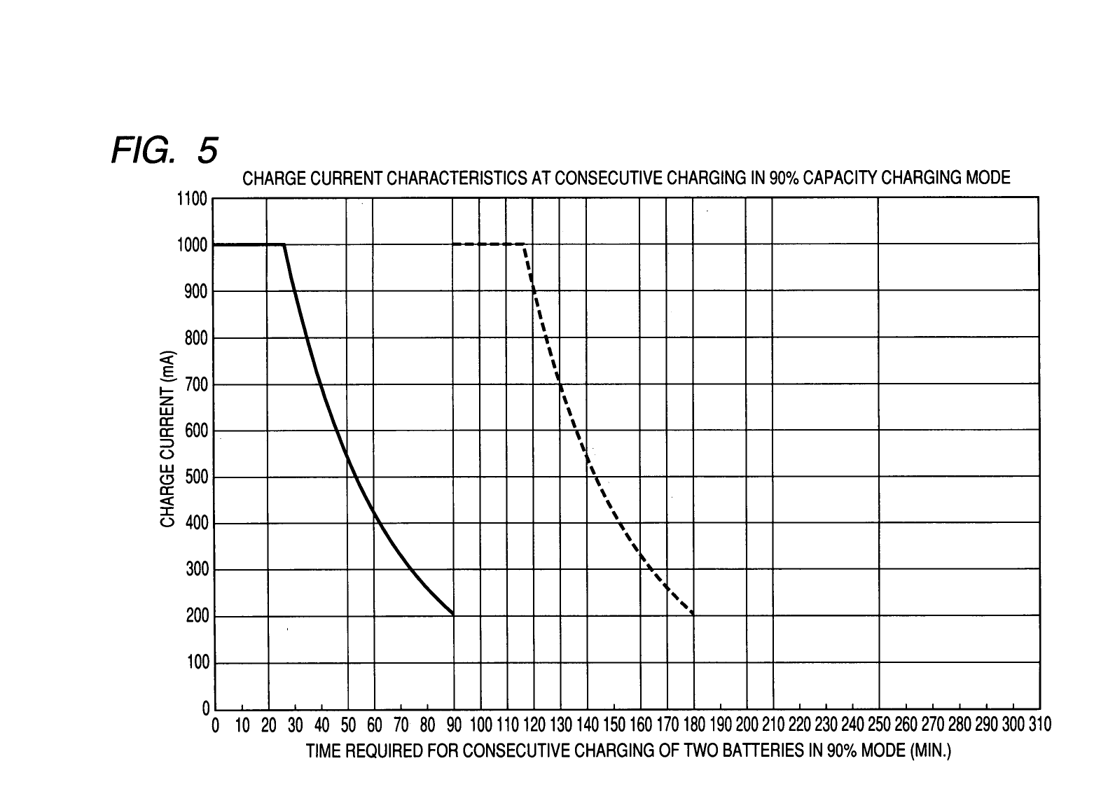

FIG. 5 is a characteristic diagram showing charge current characteristics of the battery pack 6 mounted in the battery slot A and the battery pack 7 mounted in the battery slot B, observed when the 90% charging mode is selected.

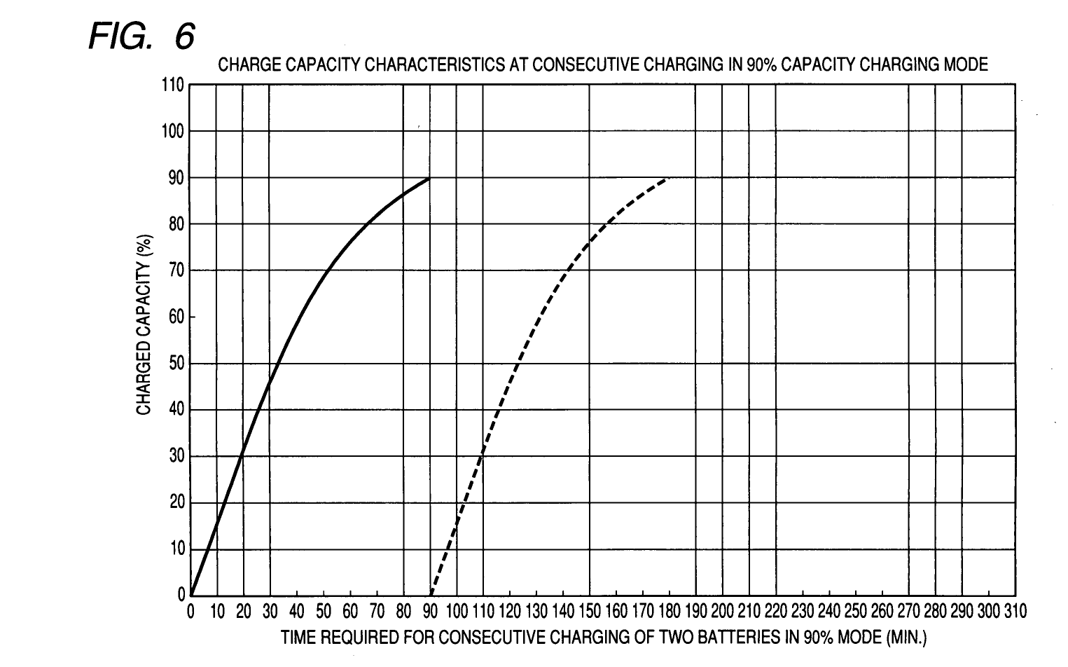

FIG. 6 is a characteristic diagram showing charge capacity characteristics of the battery pack 6 mounted in the battery slot A and the battery pack 7 mounted in the battery slot B, observed when the 90% charging mode is similarly selected.

The charge current characteristics shown in FIG. 5 indicate that it takes 90 minutes to charge one battery pack 90 percent. Therefore, it takes 180 minutes in total to charge the two battery packs 6 and 7 90 percent in a consecutive manner.

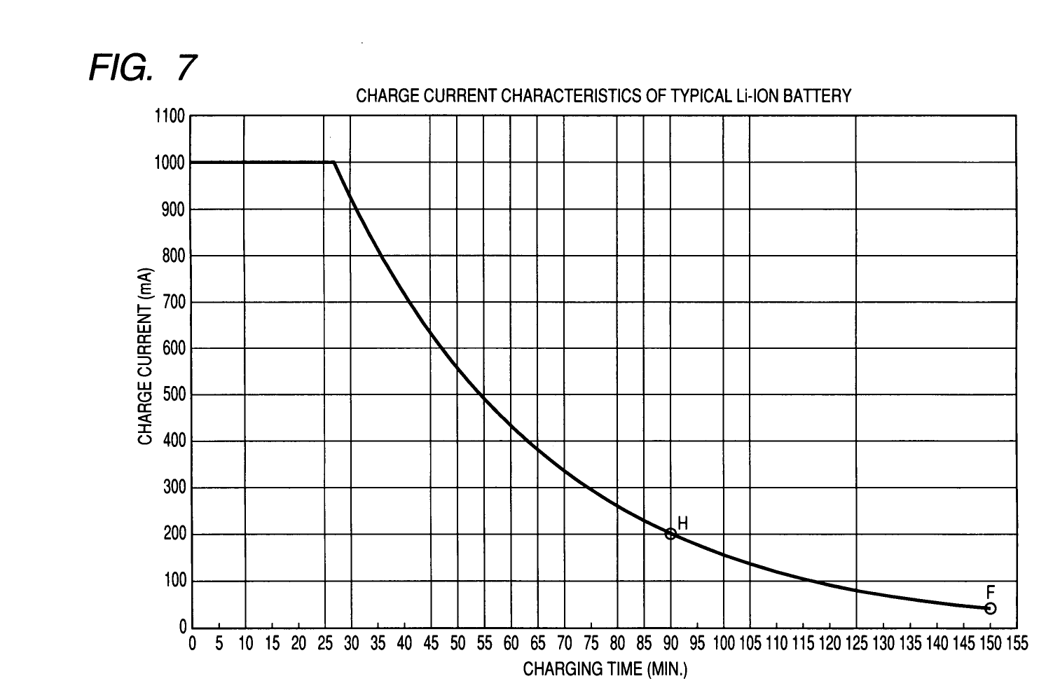

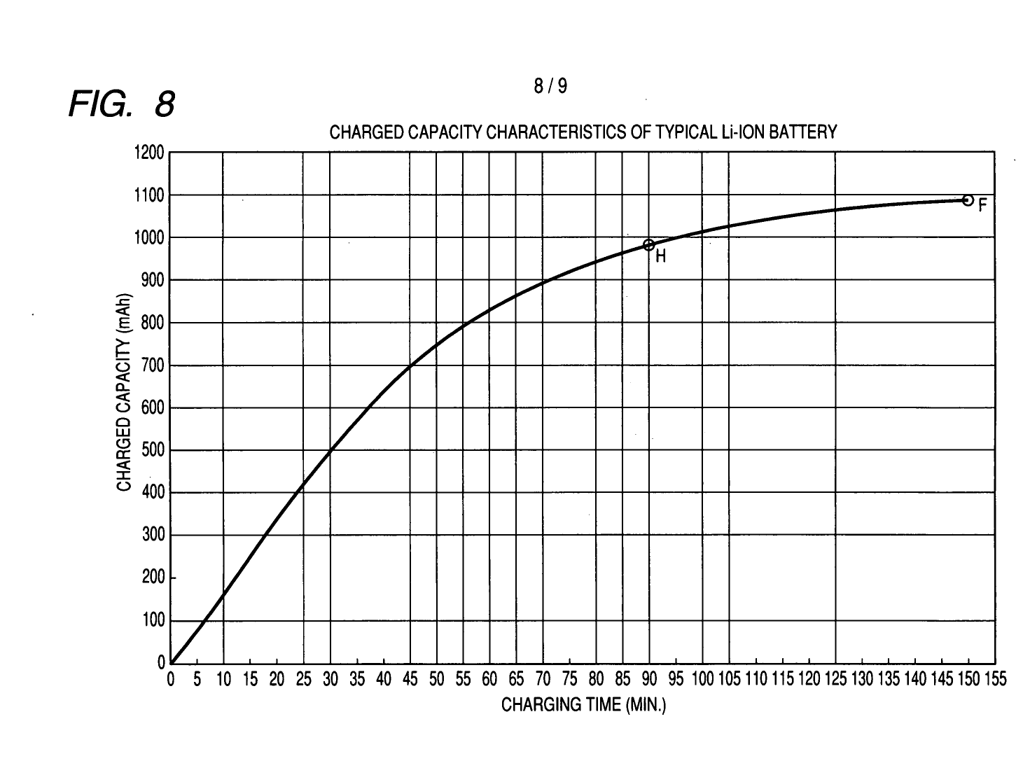

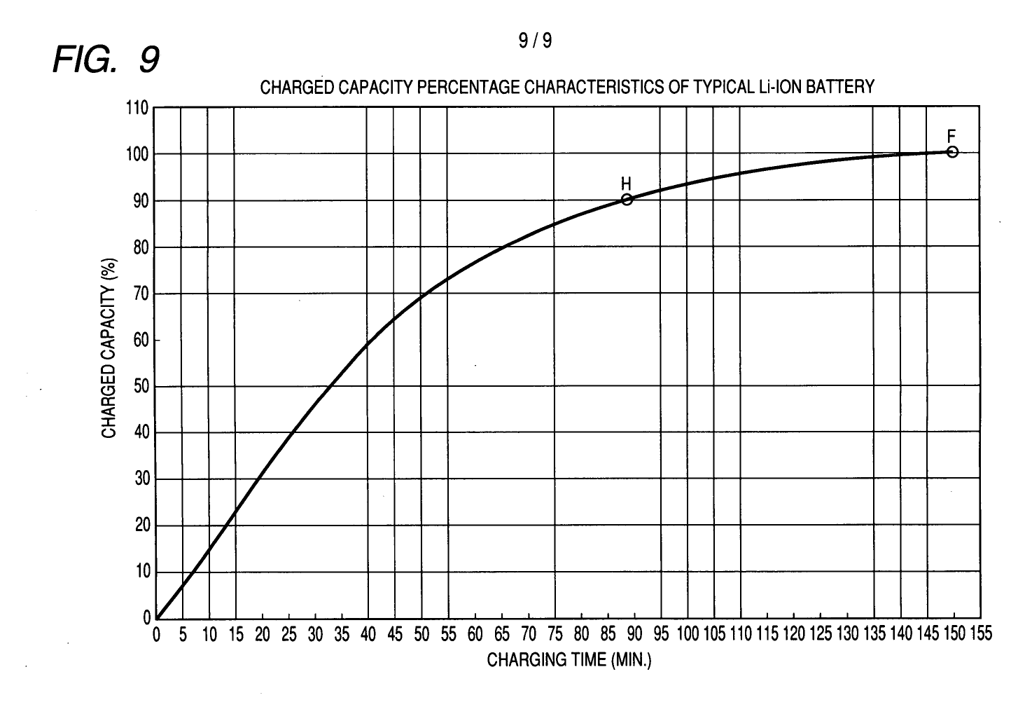

FIG. 7 is a characteristic diagram showing changes in a charge current which occur when a battery pack including lithium ion batteries having a nominal capacity of 1000 mAh is charged with a current of 1 A. FIG. 8 is a characteristic diagram showing charge capacity characteristics of the same battery pack. FIG. 9 is a characteristic diagram showing charge capacity percentage characteristics of the same battery pack. As will be apparent from those figures, in the period from the point indicated by H which comes 90 minutes after the beginning of charging until the point indicated by F when a substantially fully charge state is achieved, the battery pack including lithium ion batteries undergoes smaller changes in the charge current and charge capacity compared to those occurring in the period from the beginning of charging until the point indicated by H.

That is, charging is performed with higher efficiency in the period from the beginning of charging until the point indicated by H which comes 90 minutes after the beginning of charging when compared to the efficiency of charging performed in the period from the point which comes 90 minutes after the beginning of charging until the point indicated by F when a substantially fully charged state is achieved.

Therefore, each battery pack may be charged with high charging efficiency up to the point indicated by H which comes 90 minutes after the beginning of charging as shown in FIGS. 7, 8, and 9. Thus, higher charging efficiency can be achieved compared to charging methods according to the related art in which each battery pack is charged 100 percent.

For example, when a plurality of battery packs are to be charged by the charging apparatus of the present embodiment, each of the battery slots A and B is loaded with a battery pack to perform consecutive charging in which two batteries are charged at a time.

In this case, since it takes 150 minutes to charge one battery pack in the 100% charging mode, it takes 450 minutes to charge three battery packs in the 100% charging mode. As a result of the charging for 450 minutes, a battery pack having a 300% charge capacity (capable of a 300% discharge) equivalent to three battery packs charged 100% is obtained.

On the contrary, since it takes 90 minutes to charge one battery pack in the 90% charging mode, five battery packs charged to 90% of their charge capacity can be obtained in 450 minutes. That is, as a result of the charging for 450 minutes, a battery pack having a 450% charged capacity (cable of a 450% discharge) equivalent to five battery packs charged 90% can be obtained.

Therefore, when the 90% charging mode is selected, a 50% improvement in charging efficiency can be achieved when compared to efficiency achievable in the 100% charging mode. Such an improvement in charging efficiency is more significant, the greater the number of battery packs to be charged.

As described above, in the present embodiment of the invention, the 90% charging mode or the 100% charging mode can be selected by operating the charge ending mode select switch 3. Therefore, when high attention is paid to charging efficiency, the 90% charging mode may be selected, which is advantageous in that charging can be carried out in a shorter time with higher efficiency than in the 100% charging mode.

When it is desired to use a small number of battery packs by charging them to 100% of their charge capacity, the 100% charging mode may be selected. Thus, the apparatus is advantageous in that it has high user-friendliness.

In the above description, the apparatus has been described as having two battery slots, i.e., the battery slots A and B. Alternatively, three or more battery slots may be provided. In addition, a plurality of charging circuits may be provided. In this case, each charging circuit serves a plurality of battery slots, and the control block executes the charging process shown in the flow chart of FIG. 2 on battery packs mounted in the set of battery slots served by each charging circuit.

According to the above description, the apparatus has the 100% charging mode and the 90% charging mode, and the charge ending mode select switch 3 is operated to select either the 100% charging mode for charging a battery pack up to 100% of its charge capacity or the 90% charging mode for charging a battery pack up to 90% of its charge capacity. Referring to the 90% charging mode, charging may be ended before a 90% charged state is reached or just before the fully charged state is reached. That is, the invention is not limited to the 90% mode, and the same advantage as described above can be achieved in an 85% charging mode or a 95% charging mode.

It should be understood by those skilled in the art that various modifications, combinations, sub-combinations, and alterations may occur depending on the design requirements and other factors insofar as they are within the scope of the appended claims or the equivalents thereof.

What is claimed is:

1. A charging apparatus charging a plurality of batteries having at least two modes including a first mode and a second mode in which amounts of electricity to charge the batteries are set with reference to a fully charged capacity of the batteries, the apparatus comprising:
mode selection means for selecting either of the first mode and the second mode, wherein
the first mode is a mode in which the batteries are charged until the batteries reach a fully charged state, and
the second mode is a mode in which the charging of the batteries is stopped before the batteries reach the fully charged state.

2. A charging apparatus according to claim 1, wherein, in the second mode, the amount of charge with reference to the fully charged capacity of the batteries is set to be 90 percent of the fully charged capacity of the batteries, and the charging of the batteries is stopped before the batteries are fully charged or when 90% of the fully charged capacity of the batteries is reached.

3. A charging apparatus according to claim 1, further comprising a display section displaying the state of charging of the batteries.

4. A charging apparatus according to claim 3, wherein, when the first mode is selected, the display section provides a state indication according to the amount of charge accumulated in the batteries and a state indication indicating that the batteries have reached a fully charged state.

5. A charging apparatus according to claim 3, wherein, when the second mode is selected, the display section provides a state indication according to the amount of charge accumulated in the batteries.

6. A charging method for charging a plurality of batteries comprising the steps of:
setting amounts of electricity to charge the batteries with reference to a fully charged capacity of the batteries to provide a first mode in which the batteries are charged until the batteries reach a fully charged state and a second mode in which the charging of the batteries is stopped before the batteries reach the fully charged state; and
charging the plurality of batteries according to a result of selection made by mode selection means for selecting and enabling either of the first mode and second mode.

7. A charging apparatus charging a plurality of batteries having at least two modes including a first mode and a second mode in which amounts of electricity to charge the batteries are set with reference to a fully charged capacity of the batteries, the apparatus comprising:
a mode selection unit configured to select either of the first mode and the second mode, wherein
the first mode is a mode in which the batteries are charged until the batteries reach a fully charged state, and
the second mode is a mode in which the charging of the batteries is stopped before the batteries reach the fully charged state.
